(19) United States
(12) Patent Application Publication
(10) Pub. No.: US 2024/0283140 A1
(43) Pub. Date: Aug. 22, 2024

(54) ANTENNA DESIGN FOR MOBILE ELECTRONIC DEVICES

(71) Applicant: Meta Platforms Technologies, LLC, Menlo Park, CA (US)

(72) Inventors: Mohammed Azad, Pleasanton, CA (US); Umar Azad, San Jose, CA (US); Geng Ye, Union City, CA (US)

(21) Appl. No.: 18/172,675

(22) Filed: Feb. 22, 2023

(51) Int. Cl. H01Q 1/27; H01Q 9/04

(52) U.S. Cl. CPC H01Q 1/273; H01Q 9/0407

(57) ABSTRACT

The disclosed system may include a support structure, a larger ground plane mounted to the support structure, and an antenna module that is positioned above the larger, mounted ground plane. The antenna module may include an antenna and a separate, smaller ground plane that is smaller than the mounted ground plane. As such, the antenna and the smaller ground plane may be elevated above the larger, mounted ground plane that is mounted to the support structure. Various other mobile electronic devices, apparatuses, and systems are also disclosed herein.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of a mobile electronic device that incorporates an antenna according to at least one of the designs described herein.

FIGS. 2A-2D illustrate embodiments of antenna chart comparisons between baseline antennas and the antenna designs provided herein.

FIG. 3 illustrates an antenna design in which a patch antenna is placed directly on a large ground plane.

FIG. 4 illustrates an alternative antenna design according to at least one of the embodiments described herein.

FIG. 5 illustrates a chart showing S-parameter measurements for a baseline antenna and for a patch antenna according to at least one of the designs described herein.

FIG. 6 illustrates a chart showing efficiency measurements for a baseline antenna and for a patch antenna according to at least one of the designs described herein.

FIG. 7 illustrates a chart showing directivity measurements for a baseline antenna and for a patch antenna according to at least one of the designs described herein.

FIG. 8A illustrates two different charts showing directivity measurements for previous and current antennas according to at least one of the designs described herein.

FIGS. 8B-8F each illustrate two different charts showing pathloss cumulative distribution functions for different environments in which the antenna designs described herein may be implemented.

FIG. 9 illustrates an embodiment of an antenna module elevated above a larger ground plane.

FIG. 10 is an illustration of exemplary augmented-reality glasses that may be used in connection with embodiments of this disclosure.

FIG. 11 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is directed to various antenna designs that may be used with mobile electronic devices. The antenna designs described herein may be implemented as patch antennas or as other types of antennas. In some cases, the antennas described herein may exhibit less directionality and may avoid harmonics that may be experienced by other antennas. For instance, in a virtual reality (VR) scenario, a user may be holding one or more controllers to interact with a virtual environment projected by the VR's head mounted display (HMD). In this VR scenario, the user may move their controllers in front of them, behind them, to their sides, up or down, or in any other direction. In addition to x, y, and z movements, the user may also twist or rotate their controllers.

Antennas included in the VR HMD may be designed to communicate with these ultra-mobile handheld controllers. If the antennas are mounted vertically within the VR HMD, those antennas may operate poorly when the controllers are in specific positions or orientations (e.g., when held behind the user's back). Whereas, if the antennas are mounted horizontally within the VR HMD, those antennas may operate poorly when the controllers are in different positions or orientations. Accordingly, because the user has such a wide freedom of movement with the controllers, any antennas that are overly directional and linearly polarized may function poorly in such scenarios.

The antenna designs described herein may exhibit low directionality or, stated differently, may be more omnidirectional. As such, the antenna designs described herein may operate effectively even when users move their controllers behind the HMD, below the HMD, or when the user twists or rotates their controllers. The antennas provided herein may implement designs that position the antennas above a ground plane and may use that ground plane as a reflector with diffraction from smaller patch ground edge to enhance the signal and direct the antenna's radiation in a more omnidirectional manner.

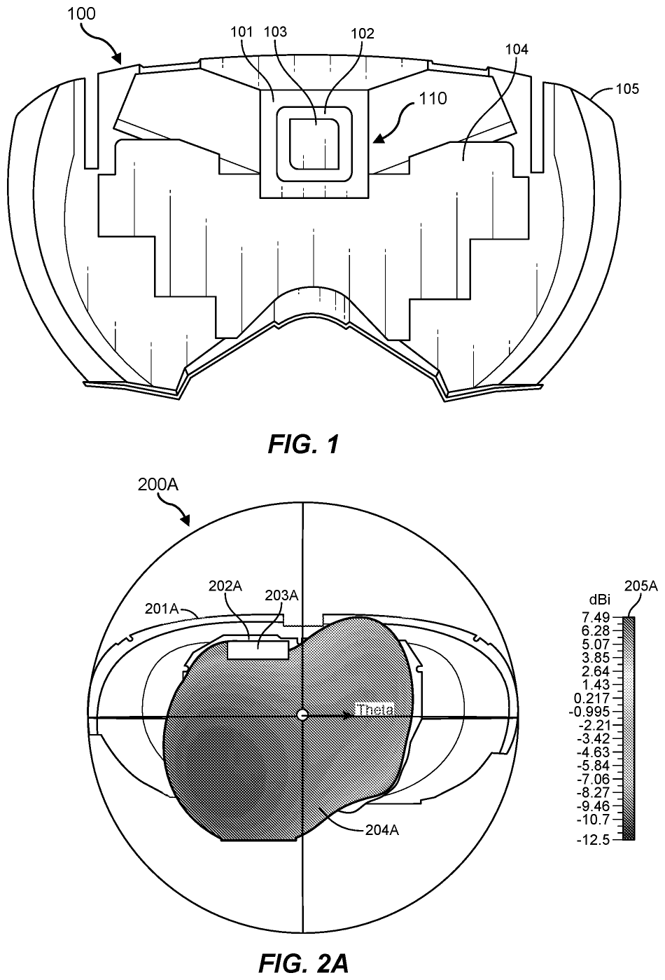

One option for placing patch antennas was directly on top of the HMD's system ground plane (e.g., directly mounted to the HMD's main logic board). This option, however, may lead to increased directionality with a higher probability of desense from the noise source on the main PCB and surroundings. In contrast, the antenna designs described herein may be separated from and raised above the HMD system's ground plane and may include their own, separate ground plane. Such a design may increase the antennas' omnidirectionality, may be more immune to noise from the desense sources on the main PCB and surrounding components, may increase signal strength, and may reduce latency, leading to fewer missed communications between the controllers and the HMD. Indeed, at least in some embodiments, the designs provided herein may exhibit a decrease in S21 link/path loss due to reduced directionality. Moreover, the designs herein may avoid secondary harmonics, particularly those near 4.8 GHz. This may further reduce path loss in VR scenarios between a VR HMD and its corresponding controllers. These embodiments will be described in further detail below with regard to FIGS. 1-11.

Features from any of the embodiments described herein may be used in combination with one another in accordance with the general principles described herein. These and other embodiments, features, and advantages will be more fully understood upon reading the following detailed description in conjunction with the accompanying drawings and claims.

FIG. 1 illustrates a system 100 such as a VR HMD that may include multiple different components. For example, the system 100 may include a support structure 105. The support structure 105 may be any kind of structural body, shell, casing, of other element to which system components may be mounted or structurally held in place. The system 100 may also include a large ground plane 104 mounted to the support structure 105. The large ground plane 104 may be separate from and may be much larger than a patch ground 101 that is part of an antenna module 110.

The antenna module 110 may be positioned above the larger, mounted ground plane 104. This may imbue the antenna module 110 (and its associated antenna trace 103 on a ceramic body 102) with specific properties. These properties may include reduced directionality and fewer secondary harmonics. The reduced directionality and reduction in harmonics may allow the antenna trace 103 to operate with greater efficiency and greater power, thereby creating better connections between VR HMDs and their corresponding controllers.

The ceramic body 102 of the antenna trace 103 may be elevated above the larger, mounted ground plane 104 that is mounted to the support structure 105. As the term is used herein, a “ground plane” may refer to an electrical element that electrically grounds components that are connected to it. The ground plane may be formed in substantially any size or shape and may be located anywhere within the system 100. In past systems, antennas would be positioned directly on top of a single system ground plane. For instance, a virtual reality head mounted display may include a main logic board (MLB), and that MLB may include groupings of traces or may include larger, contiguous portions of conductive material (e.g., metals such as copper) that form the ground plane. In such cases, the antenna would be positioned on the MLB and thus substantially next to or directly on top of the ground plane. This design would lead to antennas exhibiting high directivity.

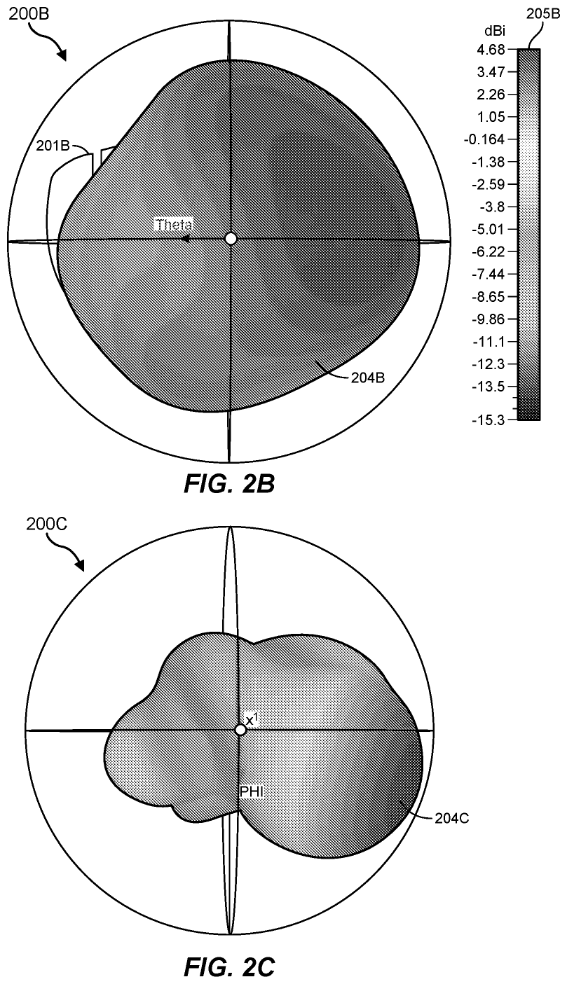

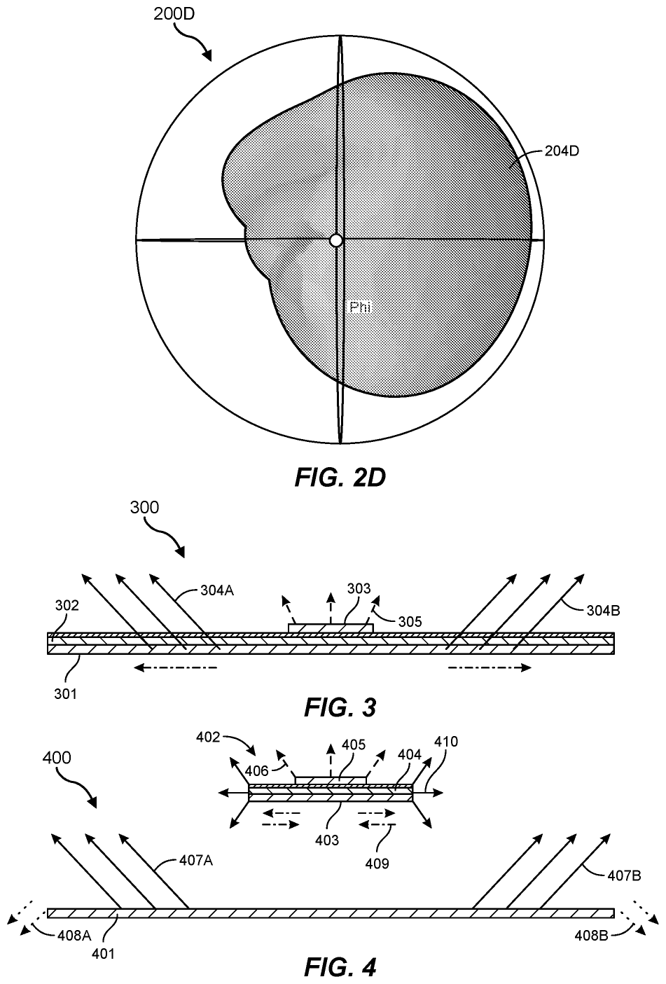

In the embodiments described herein, multiple different ground plane elements may be implemented, and those ground planes may be on different levels, with respect to each other. Moreover, these ground planes may be formed in different sizes and shapes. For instance, in some embodiments, an antenna (e.g., a patch antenna) may be positioned on a ceramic body 102, which may be collectively referred to as an antenna module (e.g., 110). The antenna module 110 may be elevated above a larger ground plane (e.g., the system ground plane in the MLB). The antenna trace 103 of the antenna module 110 may use the larger ground plane 104 as a reflecting element with diffraction from the patch antenna's smaller ground edge that reflects at least some of the signal produced by the antenna trace 103. This reflecting element may also introduce other currents and reflections that, when combined, may cause the antenna to radiate with less directivity and fewer harmonics, allowing the antenna to operate with greater power and efficiency. This concept will be described in greater detail with regard to FIGS. 2A-4.

FIG. 2A illustrates an embodiment 200A of a past VR HMD 201A that has amounted antenna 203A. This mounted antenna 203A is mounted directly above an MLB or other ground plane 202A. Although many of the examples herein refer to VR HMD devices communicating with VR controllers, it will be understood that the antenna designs described herein may be implemented with substantially any type of mobile or stationary electronic device, including augmented reality (AR) glasses, smartwatches or other wearable devices, smartphones, tablets, laptops, internet of things (IoT) devices, desktop computers, or other electronic devices that may implement antennas for wireless communication.

As can be seen in FIG. 2A, the graphical depiction of the antenna's directivity 204A illustrates a relatively high measure of directivity in some locations (e.g., in the bottom left region) of up to 7.49 dBi (205A). In contrast, the antenna designs described herein, when implemented in the VR HMD 201B of FIG. 2B, may result in a measure of directivity that is much lower (e.g., 4.68 dBi, 205B). Indeed, the graphical depiction of directivity 204B in embodiment 200B of FIG. 2B illustrates large regions that exhibit a wider coverage pattern with greater overall coverage and, specifically, better coverage in the backward direction, which antenna 203A of FIG. 2A lacks. The side views 200C and 200D of FIGS. 2C and 2D, respectively, further illustrate the strong directivity of the past antenna (e.g., 204C) and the much wider coverage pattern of the current antenna designs (e.g., 204D).

FIG. 3 illustrates an embodiment 300 of an antenna (for example, a patch antenna) 303 that was mounted directly to a main logic board 301 that has a corresponding ground plane 302. The antenna 303 may provide primary radiation 305 during operation. This primary radiation 305 may travel outward from the antenna in a highly directional manner. The antenna 303 may also exhibit secondary radiation 304A/304B from surface currents on the ground plane 302. This secondary radiation 304A/304B is emitted in a single direction away from the ground plane 302. Any surface currents traveling on the ground plane 302 decay quickly as the currents travel closer to the edge of the ground plane. This antenna 303 exhibits virtually no radiation in the backwards direction if ground plane is large (relative to the surface of the ground plane 302) and operates with a much higher directionality than the current antenna design presented in FIG. 4.

FIG. 4 illustrates an embodiment of an antenna module 402 that is elevated above a system ground plane 401 (which may be similar to or the same as ground plane 302 of FIG. 3). The antenna module 402 may be mounted above the ground plane 401 using securing elements such as wires, structural supports (e.g., made of plastic or metal), raised edges, or other physical elements which may attach to the ground plane 401 or to other mounting points within a system or device.

Regardless of how the antenna module 402 is held above the ground plane 401, the antenna module 402 may be placed in a specific position relative to the ground plane 401. For instance, in some cases, the antenna 405 may operate most effectively at a position that is 1 mm above the ground plane 401, or is 2 mm above the ground plane 401, or is 3 mm above the ground plane 401, etc. The position above the ground plane 401 may depend on the size of the antenna 405 and/or the size of the larger ground plane 401. In some cases, a prescribed ratio between the size of the antenna 405 and the ground plane 401 may dictate the optimal distance between the ground plane 401 and the antenna 405 (or the antenna module 402), with at least one factor being the device's thickness.

The antenna module 402 may include an antenna 405, as well as its own ground plane 404. This ground plane 404 of the elevated antenna module 402 may be smaller (e.g., lengthwise or widthwise or in depth) than the larger ground plane 401 (e.g., the system MLB) and may be part of a printed circuit board (PCB) 403 or other layer. In some cases, like the difference in elevation between the smaller ground plane 404 and the larger ground plane 401, the ratio in size between the smaller ground plane 404 and the ground plane 401 may also be varied to provide optimal radiating characteristics.

In some cases, for example, the width of the smaller ground plane 404 may be half of or a third of the width of the larger ground plane 401. In other cases, the width (or length or depth) of the smaller ground plane 404 may be three fourths or seven eighths or some larger amount of the width (or length or depth) of the larger ground plane 401. Thus, the size ratio between the smaller and larger ground planes may be changed in different embodiments to provide improved directivity, thereby leading to greater power transfer through the antenna 405.

In some embodiments, the antenna 405 (that is part of the antenna module 402) may be a patch antenna. In some more specific examples, the antenna 405 may be a circularly polarized (CP) patch antenna. While patch antennas or even CP patch antennas are referred to more frequently herein, it will be understood that substantially any antenna architecture (e.g., loop, monopole, dipole, inverted F, etc.) may benefit from the embodiments and antenna designs described herein.

The antenna 405 may have multiple different radiating mechanisms. For instance, the antenna 405 may exhibit primary radiation 406 that comes from the antenna directly. This primary radiation 406 may emanate outward from the location of the antenna on the antenna module 402. The antenna 405 may also exhibit secondary radiation 410 at at least one end of the smaller ground plane 404. In some cases, this secondary radiation 410 may emanate from both ends of the smaller ground plane 404 and may be radiated in substantially all directions. The secondary radiation 410 may radiate in all (or at least substantially all) directions due to diffracted electrical fields that are generated as a result of surface current reflections 409.

In contrast to directly PCB-mounted antenna systems, such as that shown in FIG. 3 in which surface current decays at the edges due to the larger ground plane, the current reflections 409 do not dissipate or decay at the edges of the smaller ground plane 404 and, instead, cause surface current reflections 409. These surface current reflections 409 may bolster the antenna's power and cause the secondary radiation 410 to radiate in all directions. Moreover, electrical fields generated by the antenna on the smaller ground 404 may extend beyond the edge of the ground plane. This provides reduced directionality, broader radiation pattern, and greater efficiency and power transfer through the antenna 405.

Still further, by elevating the antenna module 402 above the larger ground plane 401, the antenna designs described herein may allow the larger ground plane 401 to reflect radiation from the antenna 405. This reflected energy 407A/407B may be reflected in multiple directions widely, thereby even further increasing the omnidirectionality of the antenna 405. Moreover, by elevating the antenna module 402 above the larger ground plane 401, at least some radiation from the antenna 405 may continue to emanate beyond the larger ground plane 401 (e.g., energy 408A/408B) due to the distance between the antenna 405 and the larger ground plane 401.

Thus, in the embodiment 400 of FIG. 4, the antenna 405 may include multiple different radiating mechanisms including primary radiation, radiation from the antenna reflected by the larger, mounted ground plane 401, radiation that extends behind the larger, mounted ground plane 401, and radiation from the edges of the antenna module's smaller ground plane 404 due to diffracted fields at the edges of the smaller ground plane. Still other radiating mechanisms may also be included or involved in this implementation.

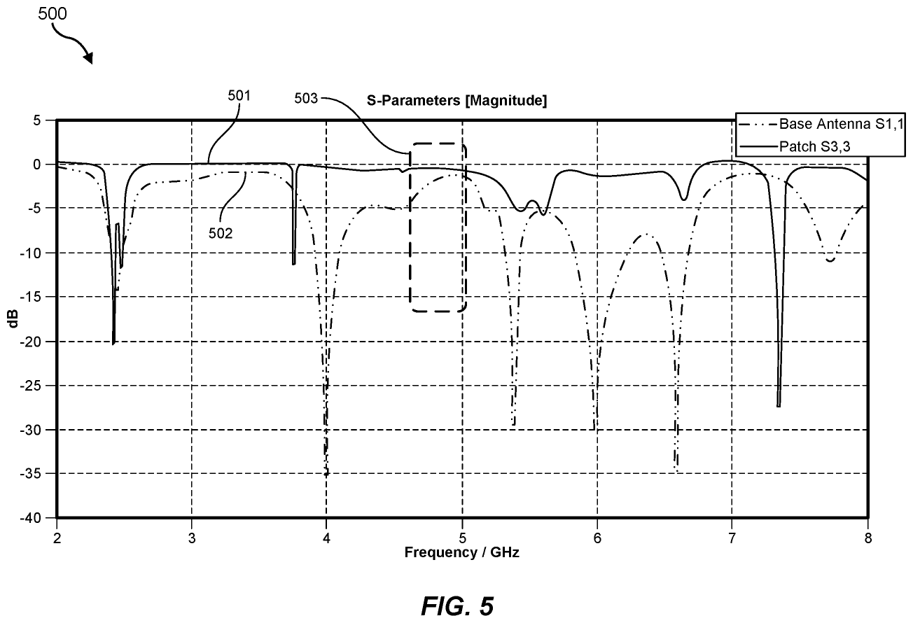

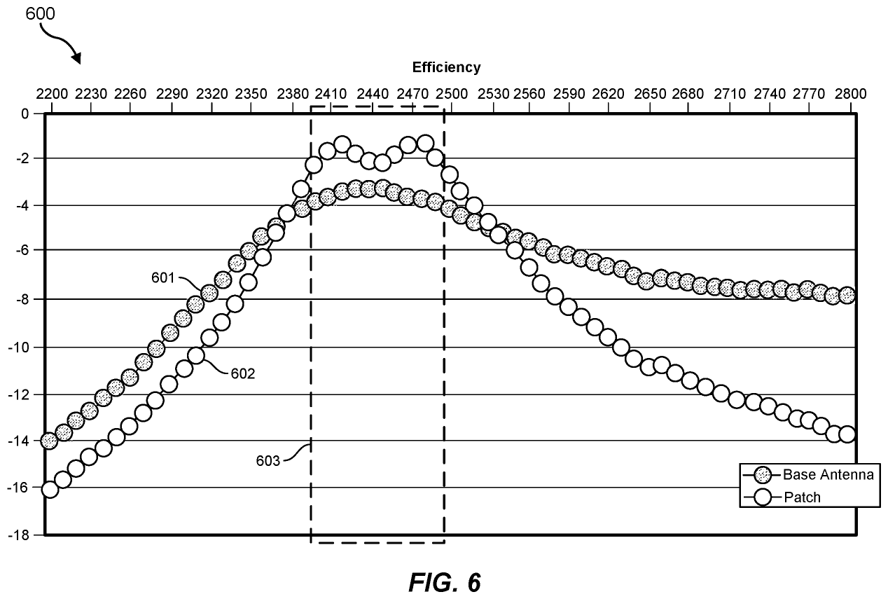

FIG. 5 illustrates a chart 500 that shows S-parameter measurements for a base antenna (e.g., as shown in FIG. 3) and a patch antenna as designed using the embodiments herein (e.g., as shown in FIG. 4). The base antenna 203A has an S11 plot 502 that shows a second harmonic occurring at point 503, while the patch antenna plot 501 shows that, at around 4.8 GHZ, no secondary harmonic exists. Other improvements are also shown in chart 600 of FIG. 6. Chart 600 illustrates measured efficiencies of a base antenna 601 and a patch antenna 602 designed according to the embodiments herein. At around 2.4 GHz (e.g., within window 603), the patch antenna 602 shows marked efficiency gains over the base antenna 601.

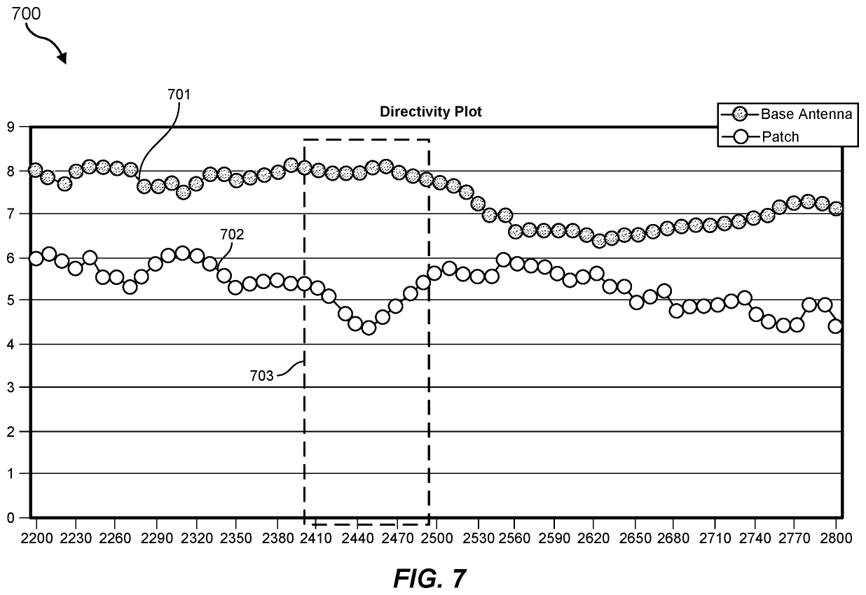

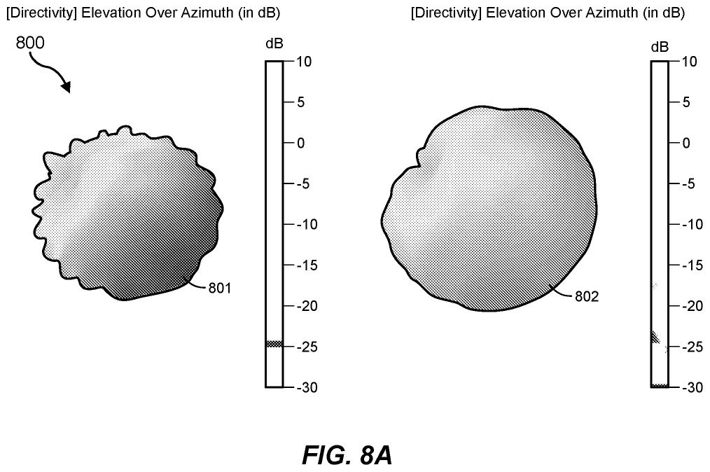

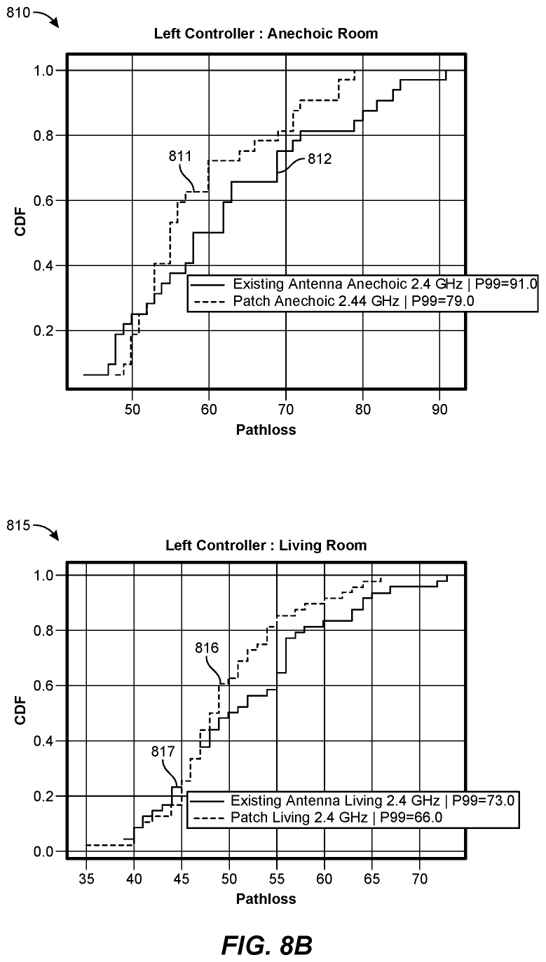

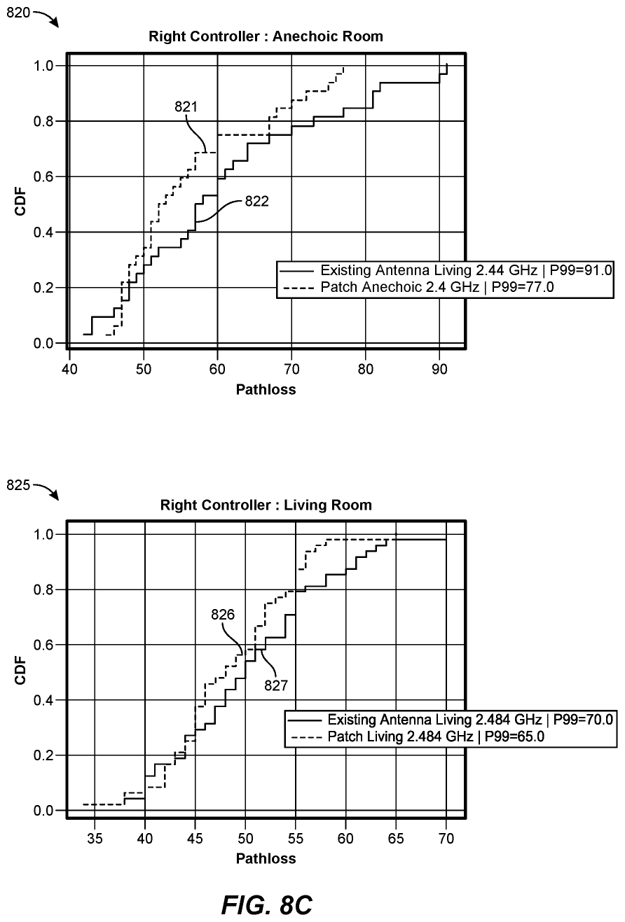

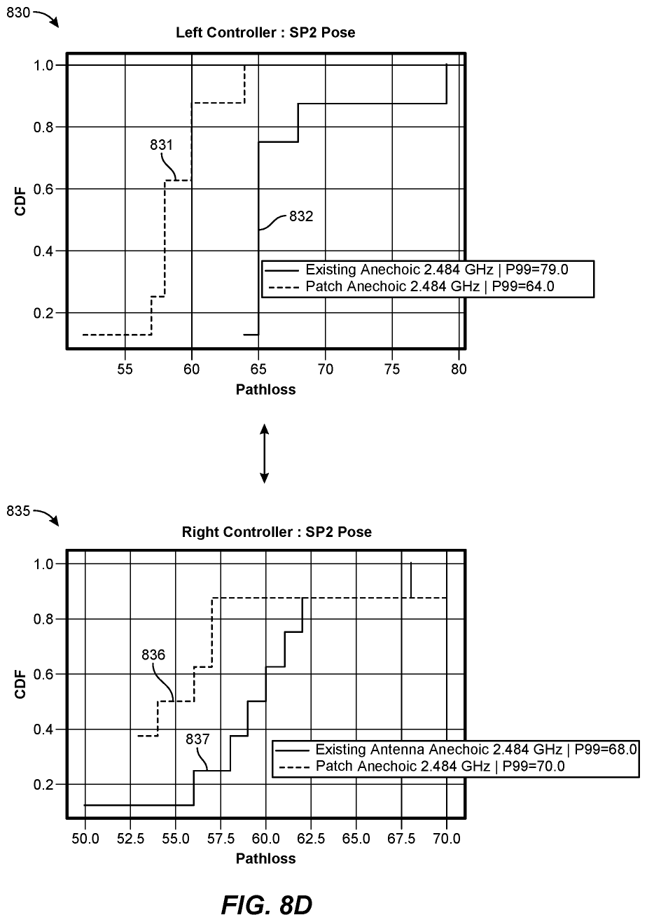

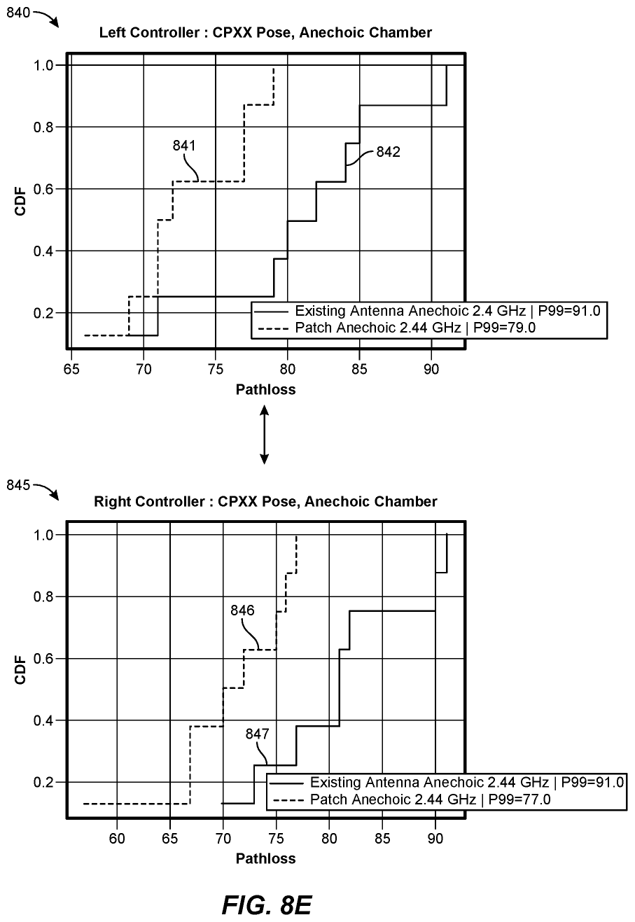

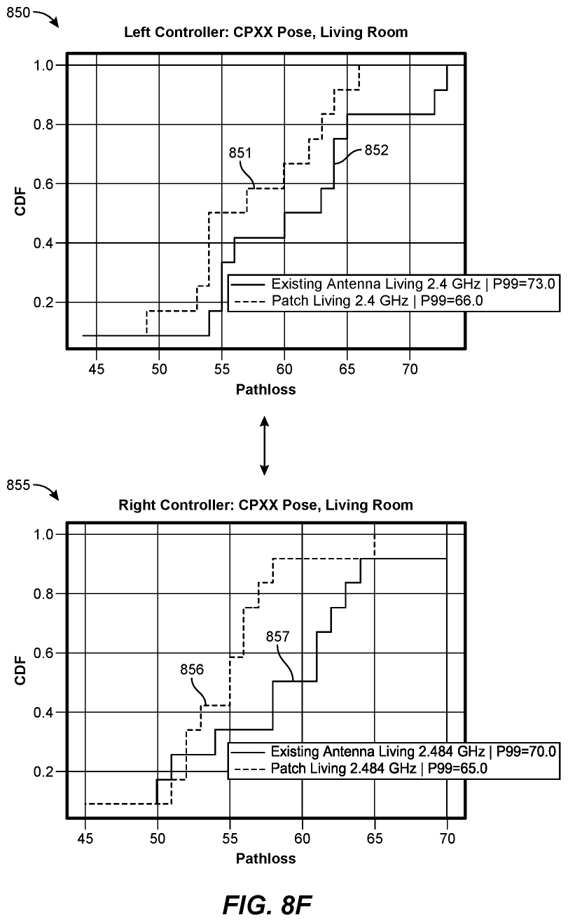

Still further, as shown in chart 700 of FIG. 7, directivity measurements may show a base antenna 701 and a patch antenna 702 designed according to the embodiments herein. Again, around 2.4 GHz (e.g., within window 703), the patch antenna shows a notable decrease in directivity. FIG. 8A illustrates an embodiment 800 with two charts showing a greatly reduced directivity associated with the user's head in the patch antenna 802 as comparted to the base antenna 801 (which may be similar to or the same as 203A in FIG. 2A).

FIGS. 8B-8F illustrate charts showing cumulative distribution functions (CDFs) of a measured pathloss of a patch antenna designed for VR headsets according to the embodiments herein. This patch antenna may be implemented with VR controllers including righthand controllers, lefthand controllers, dual-hand controllers, or other mobile electronic devices. The patch antenna described herein may be compared with existing antennas used in existing VR headsets. Each of these embodiments illustrates measurements taken in different rooms (e.g., in an anechoic room and in a living room) and in different poses. VR controllers, with their embedded antennas, may be moved to different positions relative to the user. For example, the user may move the VR controllers (and their corresponding antennas) to their front, to their back, to their left or right side, or in many different positions or rotations. Each of these positions and/or rotations may be referred to as a “pose.”

The “SP2” pose, for example, may be with the user's arm outstretched to their side, the “SP3” pose may be with the user's arm fully extended forward, the “SP4” pose may be with the user's arm partially extended forward (bent at the elbow), the “CP2” pose may be with the user's arm bent behind their back, while the “CPXX” pose may be with the user's arm resting at their side. Other poses and positions are also possible. The graphs of FIGS. 8B-8F show measurements taken in 16 different poses that represent different positions or orientations all around the user (and, more specifically, all around the VR HMD that includes the patch antenna). Having a variety of such poses ensures a proper and full measurement of the patch antennas' performance capabilities.

FIG. 8B illustrates a first chart 810 that shows the pathloss of an existing antenna 812 and the pathloss of the patch antenna as described herein 811, both of which are used in a VR HMD within an anechoic room in sixteen different poses. As can be seen in the chart 810, the patch antenna as described herein 811 in a VR HMD with the controller designed for the user's left hand may show a marked improvement over the existing antenna 812, indicating a path loss that is improved by approximately 12 dB (e.g., a P99 path loss of 79.0 vs. 91.0). In a living room, as shown in chart 815, which may include furniture, windows, walls, and other objects, the patch antenna as described herein 816 shows a path loss that is improved by approximately 7 dB (e.g., a P99 of 66.0 vs. 73.0) over that of the existing antenna 817.

FIG. 8C illustrates a first chart 820 that shows the pathloss of an existing antenna 822 and a patch antenna as described herein 821, both used in a VR HMD within an anechoic room in 16 different poses. As shown in the chart, the patch antenna as described herein 821 may be implemented in a VR HMD or other mobile electronic device, with a controller or other electronic device designed for use by a user. In this embodiment, the controller in the user's right hand may show a marked improvement over the existing antenna 822, indicating a path loss that is improved by approximately 14 dB (e.g., a P99 path loss of 77.0 vs. 91.0). In a living room, as shown in chart 825, the patch antenna as described herein 826 shows a path loss that is improved by approximately 5 dB (e.g., a P99 of 65.0 vs. 70.0) over that of the existing antenna 827.

FIG. 8D illustrates a pose in an Anechoic room referred as pose SP2. The first chart 830 that shows the pathloss of an existing antenna 832 and a patch antenna as described herein 831, both used in a VR HMD with the use of the lefthand controller in the SP2 pose in Anechoic room environment. As shown in the chart 830, the patch antenna as described herein 831 may be implemented in a VR module (or other module) with the use of the controller in the user's left hand may show a marked improvement over the existing antenna 832, indicating a path loss that is improved by approximately 15 dB (e.g., a P99 path loss of 64.0 vs. 79.0). In a right controller in the SP2 pose, as shown in chart 835, the patch antenna as described herein 836 shows a path loss that is different by approximately 2 dB (e.g., a P99 of 70.0 vs. 68.0) over that of the existing antenna 837.

FIG. 8E illustrates another pose in the Anechoic room referred as the CPXX pose. The first chart 840 that shows the pathloss of an existing antenna 842 and a patch antenna as described herein 841 both used in a VR HMD with the use of the lefthand controller in the CPXX pose in an anechoic chamber. As shown in the chart 840, the patch antenna as described herein 841 may be implemented in a VR module (or other module) with the user's lefthand controller and may show a notable improvement over the existing antenna 842, indicating a path loss that is improved by approximately 12 dB (e.g., a P99 path loss of 79.0 vs. 91.0). In a righthand controller in the CPXX pose, as shown in chart 845, the patch antenna as described herein 846 shows a path loss that is improved by approximately 14 dB (e.g., a P99 of 77.0 vs. 91.0) over that of the existing antenna 847.

FIG. 8F illustrates two charts showing CDFs of a measured pathloss of a patch antenna designed according to the embodiments herein and compared with the existing VR head mounted device antenna for in the living room in a CPXX pose. In these charts, the patch antenna designed according to the embodiments herein for VR headset may be used within lefthand and righthand virtual reality controllers and compared with the existing antenna. In chart 850, the existing antenna 852 shows a path loss of 73.0 dB with the left controller, while the patch antenna as designed herein 851 shows a path loss of 66.0 dB, a 7 dB improvement. Similarly, in chart 855, the existing antenna 857 in VR module shows a path loss of 70.0 dB with the use of the right controller, while the patch antenna as designed herein 856 shows a path loss of 65.0 dB, a 5 dB improvement. Although different poses or different ways of holding the controllers may affect the path loss, in each of the embodiments that use the patch antenna as designed herein for VR headsets, a marked reduction in path loss may be noted regardless of how or in which environment the patch antenna is used.

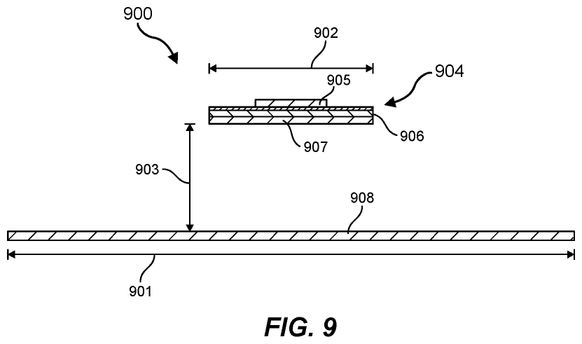

FIG. 9 illustrates an embodiment 900 of an antenna module 904 that is elevated above a larger ground plane 908. As above, the antenna module 904 may have an antenna 905, a ground plane 906, and a main logic board 907. This smaller ground plane 906 may have a specified width 902. Similarly, the larger ground plane 908 may also have a specified width 901. The antenna module 904 may be positioned at least a minimum distance 903 away from the larger, mounted ground plane. In some cases, these widths (e.g., 901 and 902) and this distance 903 between the antenna module 904 and the larger ground plane 908 may be proportional or may be set at a specific ratio. For instance, the width 902 may be set to half or one third or one fourth that of the width 901.

In some cases, the antenna module 904 may be placed closer to the larger ground plane 908 or further from the larger ground plane 908. This placement may be calculated to optimize the height of the antenna module 904 relative to the ground plane (i.e., to optimize distance 903). The antenna 905 may operate most efficiently when placed a specific distance from the larger ground plane 908. Thus, at least some of the embodiments described herein may determine the width of the larger ground plane 908 (e.g., width 901) and may determine the width of the ground plane 906 (e.g., width 902). Then, based on these widths, the systems herein may determine an optimal height 903 for the antenna module 904 to be placed above the larger ground plane 908. This distance may ensure an optimal number of reflections in some or all of the directions illustrated in FIG. 4.

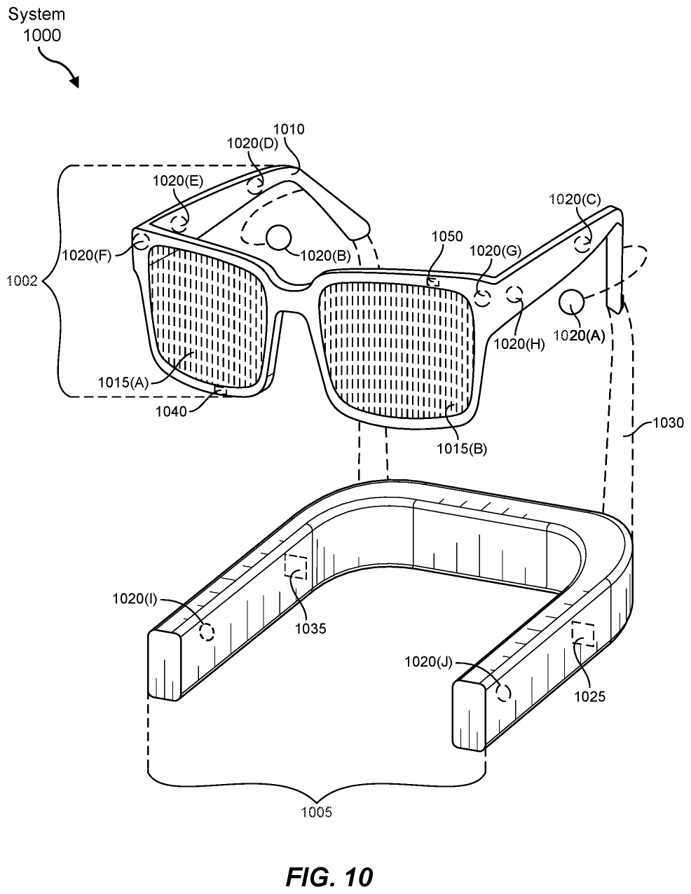

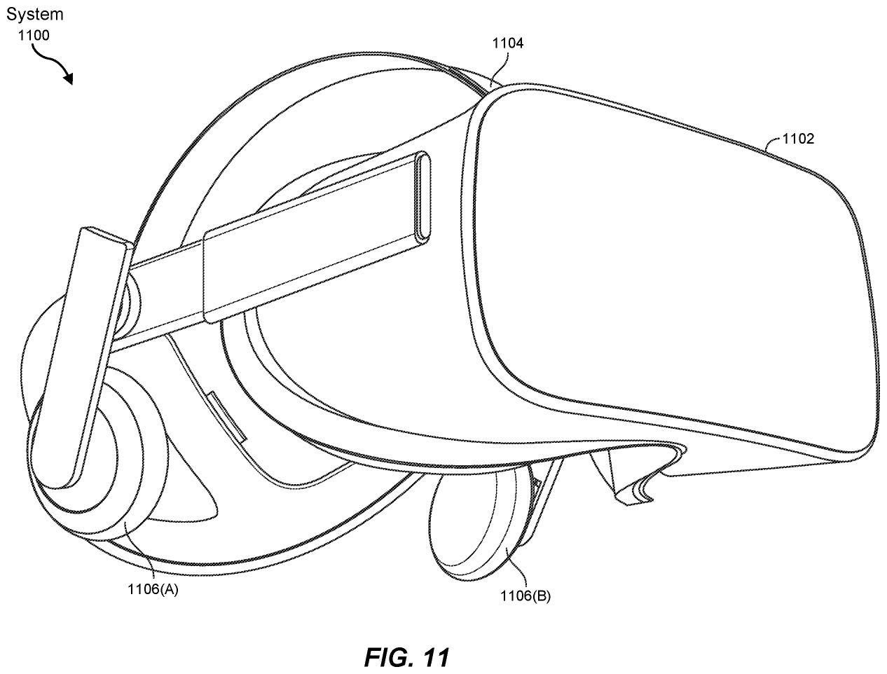

In some cases, a maximum distance 903 may be established between the antenna module 904 and the larger ground plane 908. In such cases, the antenna module 904 may be positioned closer than that maximum distance away from the larger ground plane. Similarly, in some cases, a minimum distance 903 may be established between the antenna module 904 and the larger ground plane 908. In such cases, the antenna module 904 may be positioned further than the minimum distance away from the larger ground plane 908. Accordingly, at least in some embodiments, the various widths 901/902 may be related and may be fixed at a specified ratio. Moreover, the distance 903 between the antenna module 904 and the larger ground plane 908 may also be specified and maintained for each implementation in an electronic device. As noted above, and as shown in FIGS. 10 and 11 below, such electronic devices may include a pair of augmented reality (AR) glasses (e.g., 1000), virtual reality head mounted devices (e.g., 1100), or other types of electronic devices.

In one embodiment, a mobile electronic device may include a support structure, a larger ground plane mounted to the support structure, and an antenna module that is positioned above the larger, mounted ground plane, where the antenna module includes an antenna and a separate, smaller ground plane that is smaller than the mounted ground plane, such that the antenna and the smaller ground plane are elevated above the larger, mounted ground plane that is mounted to the support structure.

In another embodiment, an apparatus may include a support structure, a larger ground plane mounted to the support structure, and an antenna module that is positioned above the larger, mounted ground plane, where the antenna module includes an antenna and a separate, smaller ground plane that is smaller than the mounted ground plane, such that the antenna and the smaller ground plane are elevated above the larger, mounted ground plane that is mounted to the support structure. In this manner, apparatuses, mobile electronic devices, and other systems may implement the antenna designs described herein to reduce directionality, reduce secondary harmonics, and thereby increase the antenna's operational efficiency and power.

### Example Embodiments

Example 1: A system may include a support structure, a larger ground plane mounted to the support structure, and an antenna module that is positioned above the larger, mounted ground plane, wherein the antenna module includes an antenna and a separate, smaller ground plane that is smaller than the mounted ground plane, such that the antenna and the smaller ground plane are elevated above the larger, mounted ground plane that is mounted to the support structure.

Example 2: The system of Example 1, wherein the antenna that is part of the antenna module comprises a patch antenna.

Example 3: The system of Example 1 or Example 2, wherein the antenna that is part of the antenna module comprises a circularly polarized patch antenna.

Example 4: The system of any of Examples 1-3, wherein the antenna module is positioned at least a minimum distance away from the larger, mounted ground plane.

Example 5: The system of any of Examples 1-4, wherein the antenna module is positioned closer than a maximum distance away from the larger, mounted ground plane.

Example 6: The system of any of Examples 1-5, wherein the length of the smaller ground plane is formed at a specified ratio of the length of the larger, mounted ground plane.

Example 7: The system of any of Examples 1-6, wherein the system includes a plurality of different radiating mechanisms.

Example 8: The system of any of Examples 1-7, wherein a first radiating mechanism includes primary radiation and wherein a second radiating mechanism includes secondary radiation at at least one end of the smaller ground plane.

Example 9: The system of any of Examples 1-7, wherein a first radiating mechanism includes primary radiation and wherein a second radiating mechanism includes radiation from the antenna reflected by the larger, mounted ground plane.

Example 10: The system of any of Examples 1-7, wherein a first radiating mechanism includes primary radiation and wherein a second radiating mechanism includes radiation behind the larger, mounted ground plane.

Example 11: A mobile electronic device may include a support structure, a larger ground plane mounted to the support structure, and an antenna module that is positioned above the larger, mounted ground plane, wherein the antenna module includes an antenna and a separate, smaller ground plane that is smaller than the mounted ground plane, such that the antenna and the smaller ground plane are elevated above the larger, mounted ground plane that is mounted to the support structure.

Example 12: The mobile electronic device of Example 11, wherein the antenna module is positioned at least a minimum distance away from the larger, mounted ground plane.

Example 13: The mobile electronic device of Example 11 or Example 12, wherein the system includes a plurality of different radiating mechanisms.

Example 14: The mobile electronic device of any of Examples 11-13, wherein a first radiating mechanism includes primary radiation and wherein a second radiating mechanism includes secondary radiation at at least one end of the smaller ground plane.

Example 15: The mobile electronic device of any of Examples 11-14, wherein a first radiating mechanism includes primary radiation and wherein a second radiating mechanism includes radiation from the antenna reflected by the larger, mounted ground plane.

Example 16: The mobile electronic device of any of Examples 11-15, wherein a first radiating mechanism includes primary radiation and wherein a second radiating mechanism includes radiation behind the larger, mounted ground plane.

Example 17: The mobile electronic device of any of Examples 11-16, wherein a first radiating mechanism includes primary radiation, wherein a second radiating mechanism includes secondary radiation at at least one end of the smaller ground plane, and wherein a third radiating mechanism includes radiation from the antenna reflected by the larger, mounted ground plane.

Example 18: The mobile electronic device of any of Examples 11-17, wherein a first radiating mechanism includes primary radiation, wherein a second radiating mechanism includes secondary radiation at at least one end of the smaller ground plane, wherein a third radiating mechanism includes radiation from the antenna reflected by the larger, mounted ground plane, and wherein a fourth radiating mechanism includes radiation behind the larger, mounted ground plane.

Example 19: The mobile electronic device of any of Examples 11-18, wherein the mobile electronic device comprises a virtual reality head mounted device (HMD), a pair of augmented reality (AR) glasses, or a smartwatch.

Example 20: An apparatus may include a support structure, a larger ground plane mounted to the support structure, and an antenna module that is positioned above the larger, mounted ground plane, wherein the antenna module includes an antenna and a separate, smaller ground plane that is smaller than the mounted ground plane, such that the antenna and the smaller ground plane are elevated above the larger, mounted ground plane that is mounted to the support structure.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(1) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented-reality system 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015(A) and 1015(B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(l) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(l) and 1020(J) may be positioned on neckband 1005, thereby increasing the distance between the neckband acoustic transducers 1020(I) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium-ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light projector (DLP) micro-displays, liquid crystal on silicon (LCOS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, bodysuits, handheld controllers, environmental devices (e.g., chairs, floor mats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a support structure;
a larger ground plane mounted to the support structure; and
an antenna module that is positioned above the larger, mounted ground plane,
wherein the antenna module includes an antenna and a separate, smaller ground plane that is smaller than the mounted ground plane, such that the antenna and the smaller ground plane are elevated above the larger, mounted ground plane that is mounted to the support structure.

2. The system of claim 1, wherein the antenna that is part of the antenna module comprises a patch antenna.

3. The system of claim 1, wherein the antenna that is part of the antenna module comprises a circularly polarized patch antenna.

4. The system of claim 1, wherein the antenna module is positioned at least a minimum distance away from the larger, mounted ground plane.

5. The system of claim 1, wherein the antenna module is positioned closer than a maximum distance away from the larger, mounted ground plane.

6. The system of claim 1, wherein the length of the smaller ground plane is formed at a specified ratio of the length of the larger, mounted ground plane.

7. The system of claim 1, wherein the system includes a plurality of different radiating mechanisms.

8. The system of claim 7, wherein a first radiating mechanism includes primary radiation and wherein a second radiating mechanism includes secondary radiation at at least one end of the smaller ground plane.

9. The system of claim 7, wherein a first radiating mechanism includes primary radiation and wherein a second radiating mechanism includes radiation from the antenna reflected by the larger, mounted ground plane.

10. The system of claim 7, wherein a first radiating mechanism includes primary radiation and wherein a second radiating mechanism includes radiation behind the larger, mounted ground plane.

11. A mobile electronic device comprising:
a support structure;
a larger ground plane mounted to the support structure; and
an antenna module that is positioned above the larger, mounted ground plane,
wherein the antenna module includes an antenna and a separate, smaller ground plane that is smaller than the mounted ground plane, such that the antenna and the smaller ground plane are elevated above the larger, mounted ground plane that is mounted to the support structure.

12. The mobile electronic device of claim 11, wherein the antenna module is positioned at least a minimum distance away from the larger, mounted ground plane.

13. The mobile electronic device of claim 11, wherein the mobile electronic device includes a plurality of different radiating mechanisms.

14. The mobile electronic device of claim 13, wherein a first radiating mechanism includes primary radiation and wherein a second radiating mechanism includes secondary radiation at at least one end of the smaller ground plane.

15. The mobile electronic device of claim 13, wherein a first radiating mechanism includes primary radiation and wherein a second radiating mechanism includes radiation from the antenna reflected by the larger, mounted ground plane.

16. The mobile electronic device of claim 13, wherein a first radiating mechanism includes primary radiation and wherein a second radiating mechanism includes radiation behind the larger, mounted ground plane.

17. The mobile electronic device of claim 13, wherein a first radiating mechanism includes primary radiation, wherein a second radiating mechanism includes secondary radiation at at least one end of the smaller ground plane, and wherein a third radiating mechanism includes radiation from the antenna reflected by the larger, mounted ground plane.

18. The mobile electronic device of claim 13, wherein a first radiating mechanism includes primary radiation, wherein a second radiating mechanism includes secondary radiation at at least one end of the smaller ground plane, wherein a third radiating mechanism includes radiation from the antenna reflected by the larger, mounted ground plane, and wherein a fourth radiating mechanism includes radiation behind the larger, mounted ground plane.

19. The mobile electronic device of claim 11, wherein the mobile electronic device comprises a virtual reality head mounted device (HMD), a pair of augmented reality (AR) glasses, or a smartwatch.

20. An apparatus comprising:
a support structure;
a larger ground plane mounted to the support structure; and
an antenna module that is positioned above the larger, mounted ground plane,
wherein the antenna module includes an antenna and a separate, smaller ground plane that is smaller than the mounted ground plane, such that the antenna and the smaller ground plane are elevated above the larger, mounted ground plane that is mounted to the support structure.
